(19) United States
(12) Patent Application Publication
(10) Pub. No.: US 2022/0201918 A1
(43) Pub. Date: Jun. 30, 2022

(54) SPACE-OPTIMISED GROUND PROCESSING DEVICE

(71) Applicant: Lemken Gmbh & Co KG, Alpen (DE)

(72) Inventors: Ludger Maas, Sonsbeck (DE); Georg Achten, Tonisvorst (DE)

(21) Appl. No.: 17/604,312

(22) PCT Filed: Apr. 15, 2020
(86) PCT No.: PCT/DE2020/100303

§ 371 Date: Oct. 15, 2021

(30) Foreign Application Priority Data
Apr. 15, 2019 (DE) 10 2019 205 438.2

(51) Int. Cl. A01B 35/18; A01B 35/06; A01B 35/14

(52) U.S. Cl. CPC A01B 35/18; A01B 35/14; A01B 35/06

(57) ABSTRACT

The present application relates to a soil tillage implement (10) having soil tillage tools (12), in particular cultivator tines, wherein the soil tillage implement (10) comprises a frame (14) in order to arrange the soil tillage tools (12) in multiple tool rows (16.1 . . . 16.4) following one another in the working direction (A) oriented transversely to the working direction (A), and a running gear (18) having at least one main wheel (20.1, 20.2) which is spaced apart from a centre longitudinal axis (22) transversely to the working direction (A) by a lateral wheel distance (dr). The running gear (18) is arranged within the frame area in such a manner that with respect to the working direction (A) in front of and preferably behind the running gear (18) as well as to the left and right of the running gear (18) at least one soil tillage tool (12) is arranged. According to the invention, all soil tillage tools (12), which are arranged in the tool row (16.1) located furthest in front of the running gear (18) in the working direction (A), have a lateral tool distance (dw) from the centre longitudinal axis (22) that is smaller than or equal to the lateral wheel distance (dr).

The present invention relates to a soil tillage implement having soil tillage tools, in particular cultivator tines such as for example wing share cultivator tines, wherein the soil tillage implement comprises a frame in order to arrange the soil tillage tools in multiple tool rows following one another in the working direction oriented transversely to the working direction over a frame area, and to a running gear having at least one main wheel which is spaced apart transversely to the working direction by a lateral wheel distance from a centre longitudinal axis. The running gear is integrated, i.e. arranged within the frame area so that with respect to the working direction at least one soil tillage tool is arranged in front of and preferably behind the running gear as well as to the left and right of the running gear.

The present invention generally relates to a soil tillage implement which can be pulled over the ground with a towbar behind a tractor in order to cultivate the soil. In particular, the soil tillage implement can be a cultivator, wherein the invention described in the following can also be applied to similar soil tillage implements, i.e. soil tillage implements with a similar construction and/or similar arrangement of soil tillage tools, for example ploughs. The soil tillage implement is supported by a height-adjustable running gear, which can also be employed in order to transport the soil tillage implement in a transport position on public roads between different places of operation.

Mechanisms, such as for example traction boosters generally known for such soil tillage tools, in the case of which the force or weight distribution between tractor and soil tillage implement can be adjusted or changed, folding mechanisms, by means of which a width of the soil tillage implement can be reduced to a value that 30 is permissible for public roads or increased to a value that is efficient for the soil tillage as well as additional tools such as levelling tools, rollers, flexible harrows and the like can be particularly advantageous in connection with the present invention. Thus, the invention is particularly suitable for soil tillage implements comprising the corresponding mechanisms.

From DE 2011 107 533 U1 and EP 2 589 282 A1 a soil tillage implement with wing share cultivator tines is known, in the case of which the individual cultivator tines are fastened to a three-row frame and are distributed over the frame area defined by the edge of the said frame. Disadvantageous in this soil tillage implement is its expansive design, which is the result in particular of the running gear being arranged only behind the frame. Among other things, this configuration results in that a combination of tractor and soil tillage implement has a large turning circle, which during the operation, in particular the turning on the field, results in inefficiency.

There are solutions of soil tillage implements in which the running gear is integrated in the frame in order to improve the manoeuvrability of the combination. These implements have the disadvantage among others that the arrangement of the cultivator tines or of other soil tillage tools over the frame is not selected so that a high-quality even cultivation of the soil is possible.

On the one hand, the known soil tillage implements with integrated running gear often have a substantial side draft, namely when the soil tillage implement is not configured symmetrically about the centre longitudinal axis of the implement, i.e. for example more soil tillage tools engage in the ground on one side of the centre longitudinal axis than on the other side. Among other things, this problem also results in major difficulties in carrying-out a neat connecting run in which the soil tillage has to take place as exactly as possible next to the previous soil tillage.

In order to avoid this disadvantage there are frame concepts in which the soil tillage tools are arranged in four and more rows. On the other hand, this results in the problem that the lateral distance of the soil tillage tools in the last row is greater than in a soil tillage implement having the same number of soil tillage tools distributed over only three rows. The lateral distance of the soil tillage tools in the last row has a major influence on the evenness of the soil tillage. In the case of a relatively large distance, a more elaborate levelling of the dams between the tines resulting from the soil cultivation is required.

Before this background, an object of the present invention consists in providing a soil tillage implement having soil tillage tools in which the soil tillage tools are arranged so that a high level of manoeuvrability, neat connecting runs and an even soil tillage are achieved. A further object of the invention consists in achieving an optimal installation space utilisation of the frame area in order to be able to produce the implement in as compact and efficient a manner.

This object is solved through the soil tillage implement according to claim 1. Advantageous further developments of the invention are obtained from the subclaims.

A soil tillage implement of the above technical area having soil tillage tools, in particular cultivator tines, comprises a frame in order to arrange the soil tillage tools in multiple tool rows following one another in the working direction and oriented transversely to the working direction over a frame area, and a running gear having at least one main wheel, which is spaced apart transversely to the working direction by a lateral wheel distance from a centre longitudinal axis. The running gear is arranged within the frame area in such a manner that with respect to the working direction in front of and preferably behind the running gear as well as to the left and right of the running gear at least one soil tillage tool is arranged. According to the invention it is thereby characterised that all soil tillage tools, which are arranged in the tool row located furthest in front of the running gear in the working direction, have a lateral tool distance from the centre longitudinal axis that is smaller than or equal to the lateral wheel distance.

Because of the fact that all soil tillage tools, which are arranged in the tool row located furthest in front of the running gear in the working direction, have a lateral tool distance from the centre longitudinal axis that is smaller than or equal to the lateral wheel distance, the soil tillage tools can be displaced further towards the front relative to the actual frame extending over the entire working width without having a disadvantageous effect on the manoeuvrability of the soil tillage implement. Because of this, the possibility arises to integrate the running gear within the frame area at the same time. The soil tillage tools otherwise located in the place of the running gear with even and symmetrical arrangement in each row can be arranged in front of the front-most complete row and, provided these are arranged according to the invention, be arranged without negatively affecting manoeuvrability, evenness or freedom of side draft.

In other words, based on a, for example three-row frame with the soil tillage tools arranged symmetrically to the centre longitudinal axis similar to the arrangement from the abovementioned DE 2011 107 533 U1 and EP 2 589 282 A1, one or more for example three soil tillage tools in the centre are displaced forward in front of the previously front-most row in order to create space for the running gear in the middle and without having to newly adjust the distances of the remaining soil tillage tools relative to one another at the same time.

In the present context, a main wheel or multiple main wheels is to mean in particular the wheel or the wheels which, in contrast with one or more support wheels, continuously absorb/s a greater weight force during the utilisation of the soil tillage implement or at least during transport or turning operations.

The wheel distance mentioned above is to mean the distance between an outer edge of the main wheel and the centre longitudinal axis. The width of the main wheel concerned is thus included in the wheel distance. The tool distance in the present context similarly means the distance between an outer edge of the tool concerned and the centre longitudinal axis.

The feature according to which all soil tillage tools which are arranged in the tool row located furthest in front of the running gear in the working direction have a lateral tool distance from the centre longitudinal axis that is smaller than or equal to the lateral wheel distance is thus fulfilled in particular when all of the mentioned soil tillage tools are located at a distance interval between the centre longitudinal axis and the edge of the main wheel or of the (outer-most) main wheels facing away from the centre longitudinal axis within the frame area.

Through the arrangement according to the invention it is not only ensured that manoeuvrability of the implement, freedom of side draft during the utilisation of the implement and evenness of the tillage are achieved. It also makes possible a high level of stability since the front-most soil tillage tools, seen in the working direction, are located in the front region of a triangle between the outer-most contact points of the running gear and the support point of the soil tillage implement on a tractor or the like, for example at the end of a towbar of the soil tillage implement. Thus, the running gear can guide the soil tillage in a stable manner.

Preferably, the running gear comprises two main wheels which are spaced apart from the centre longitudinal axis by the same lateral wheel distance each. By way of two main wheels the stability of the soil tillage implement about the longitudinal axis can be increased without making necessary a particularly wide main wheel.

Advantageously, all soil tillage tools arranged in the rear-most tool row in the working direction are equidistantly spaced apart from their laterally adjacent soil tillage tools of the same tool row, namely by a tine spacing. This arrangement of the last soil tillage tools makes possible an even tillage pattern which, depending on the spacing of the last soil tillage tools from one another, need no longer be levelled or at least not unevenly so. For levelling the tillage pattern left behind by the soil tillage tools, levelling tools can be employed behind the soil tillage tools in the fundamentally known manner. For this purpose, rollers, disc tools, guide blades and/or flexible harrows are suitable for this purpose.

Further preferably, the tool row located furthest in front of the running gear in the working direction is a part tool row which extends over less than half of a working width of the soil tillage implement, wherein the soil tillage tools of the soil tillage implement are arranged in addition to the front-most part tool row in a number R, preferably between two and four, particularly preferably three main tool rows substantially extending over the entire working width of the soil tillage implement. In the case of three main tool rows, each of the soil tillage tools of the middle of the three main tool rows is displaced to the inside towards the centre longitudinal axis relative to one of the soil tillage tools of the rear-most of the three main tool rows by a third of the tine spacing between adjacent soil tillage tools of the rear-most of the three main tool rows (tine spacing of the rear-most of the three main tool rows). Furthermore, the running gear is arranged with respect to the working direction in a region of the middle of the three main tool rows and each of the soil tillage tools of the front-most of the three main tool rows up to the two soil tillage tools located next to the centre longitudinal axis of the front-most of the three main tool rows by a third of the tine spacing between adjacent soil tillage tools of the rear-most of the three main tool rows.

More generally, in the case of R main tool rows, each of the soil tillage tools of a main tool row in the working direction in front of the rear-most main tool row, whose lateral tool distance from the centre longitudinal axis is greater than the lateral wheel distance, is displaced, relative to one of the soil tillage tools of the R main tool rows following directly at the back in the working direction, by one/R-times the tine spacing towards the inside towards the centre longitudinal axis. Here, the running gear is arranged with respect to the working direction in a region of a main tool row in front of the rear-most main tool row.

Graphically, the tools of the front-most part tool row have been taken from that tool row in which the running gear is now located, for example, from the middle tool row and arranged in front of the front main tool row. In other words, the soil tillage tools, based on an arrangement in R, for example three rows extending over the working widths are switched so that now R+1, for example four rows of soil tillage tools are now present, but of which the front-most row, i.e. the soil tillage tools that are arranged in the tool row located further in front of the running gear in the working direction, are only distributed over a middle part of the working width in order to maintain the manoeuvrability and also the evenness of the tillage of the R-row, for example three-row soil tillage implement.

The two soil tillage tools located next to the centre longitudinal axis of the front-most of the three main tool rows are preferentially displaced relative to one of the main wheels by a third of the tine spacing between adjacent soil tillage tools of the rear-most of the three main tool rows to the inside towards the centre longitudinal axis, in particular when the main wheels substantially have the same lateral wheel distance to the centre longitudinal axis as the lateral tool distance of the outer tools of the front-most (part) tool row.

This arrangement of the soil tillage tools in the soil tillage implement has proved to be particularly suitable. By displacing the respective soil tillage tools arranged in each case in front of a certain main tool row to the inside towards the centre longitudinal axis it is ensured that the working width of the respective main tool rows has a tendency to decrease from the rear towards the front which contributes to the stability of the soil tillage implement. Furthermore, an even spacing of the individual soil tillage tools in the soil tillage implement is achieved by the dimension of the displacement.

The working width of the soil tillage implement in this configuration (but not only in this configuration) is defined by the rear-most tool row, the main tool rows located further at the front taper with respect to the rear-most tool row by 1/R each of the mutual distance of the tools in the rear-most tool row on each side of the centre longitudinal axis, in particular, in the case of three main tool rows, the middle and front main tool row taper with respect to the rear-most tool row by ⅓ each of the mutual distance of the tools in the rear-most tool row on each side of the centre longitudinal axis. Insofar, the expression that the main tool rows “substantially” extend over the entire working width is to mean that a main tool row still extends substantially over the entire working width when it recedes to the inside altogether not further than one times the lateral distance of adjacent soil tillage tools in the last main tool row (the tine spacing) relative to the last main tool row. Regarding the definition of a main tool row it should be noted, furthermore, that a soil tillage tool which relative to other soil tillage tools of a tool row is displaced in the working direction by up to half a distance between consecutive main tool rows is still considered as belonging to that tool row.

Advantageously, at least one soil tillage tool each is arranged in the working direction aligned behind the main wheel or the main wheels in substantially the same lateral position relative to the centre longitudinal axis of the soil tillage implement so that the soil compacted by the main wheel or the main wheels can be tilled by the soil tillage tool concerned, in particular loosened up again.

In a preferred embodiment, the same number of soil tillage tools are arranged on both sides outside the centre longitudinal axis. This means that for example in the case of an uneven number of soil tillage tools per row, soil tillage tools can also be arranged centrally, i.e. on the centre longitudinal axis. In this way it can be easily achieved that no side draft by the soil tillage implement occurs.

Preferably, with respect to the working direction to the left and right next to the tool row located furthest in front of the running gear in the working direction and in the same position along the working direction as the said tool row, at least one front support wheel each is arranged, so that the soil tillage tools of that tool row are flanked by the front support wheels.

Alternatively and additionally it is preferred that to the left and right with respect of the working direction next to a tool row located further back, in particular the penultimate tool row, at least one rear support wheel each is arranged, so that the soil tillage tools of this tool row are flanked by the rear support wheels, wherein preferably aligned in the working direction behind the respective at least one rear support wheel a soil tillage tool is arranged, which in particular is arranged in the last tool row.

By way of the support wheels the stability of the soil tillage implement is increased and the depth guidance of the soil tillage tools can, besides the running gear, i.e. the main wheels, also take place with the help of the support wheels. When one or more support wheels are arranged behind the main wheel there is the possibility of compensating for a negative support load during the work. For this purpose it is preferred that the support wheel or the support wheels is or are arranged approximately 30 cm behind the main wheel or the main wheels. This distance makes possible realising this effect without having to generate particularly large forces through the support wheel or the support wheels when the lever arm between support wheel and main wheel is small, and without having to relinquish the advantage of a compact design when the lever arm between the support wheel and the main wheel becomes large.

Preferentially, in this embodiment, a soil tillage tool is provided beside the lateral support wheel in such a manner that the soil tillage tool in the working direction is arranged behind a front edge of the support wheel. Thus it can be prevented that soil is conveyed in front of the support wheel. It is preferred, furthermore, that aligned in the working direction behind the support wheel at least one soil tillage tool is arranged in order to till a tyre track of the support wheel and thus achieve a more even tillage pattern.

In a preferred embodiment of the invention, some, in particular eight, soil tillage tools are arranged on a middle frame segment and two or more, in particular three soil tillage tools of these form the tool row located furthest in front of the running gear in the working direction. Further preferably, a plurality each of in particular at least ten soil tillage tools are arranged on a left lateral frame segment and a right lateral frame segment, so that the soil tillage implement in particular comprises at least 28 soil tillage tools. The lateral frame segments are preferably each foldable relative to the middle frame segment about a folding axis running preferentially parallel to the working direction in order to switch the soil tillage implement between a working position and a transport position and the running gear is preferably arranged on the middle frame segment and support wheels are optionally arranged on the lateral frame segments. At the same time, an adaptation of the lateral parts for maintaining the working depth transversely to the main working direction in uneven terrain/soil surface is achieved.

This distribution of the soil tillage tools over the frame area has proved to be particularly suitable for soil tillage implements that have a working width of nine to twelve meters. This preferred number and distribution of soil tillage tools leads to an even and efficient soil tillage because the soil tillage implement can be configured symmetrically, in a highly manoeuvrable and compact a manner and yet with a large working width.

In a particularly preferred embodiment, the soil tillage tools are cultivator tines, in particular wing share cultivator tines and goosefoot share cultivator tines. The soil tillage implement, further preferably, comprises additional tools which are arranged in the working direction in front of the cultivator tines in multiple additional tool rows following one another in the working direction and oriented transversely to the working direction. The additional tools can be preferentially six discs, hollow discs, cross-cutters, rollers, clearing blades or star discharge rollers, levelling tools or cross-boards.

Here, a rear-most additional tool row is arranged substantially with respect to the working direction to the left and right next of the tool row located furthest in front of the running gear in the working direction and along the working direction in the same position as that tool row, wherein in the working direction in front of the rear-most additional tool row preferably a middle additional tool row is arranged and wherein in the working direction in front of the rear-most and preferably in front of the middle additional tool row a front-most additional tool row is arranged. All additional tools that are arranged in the front-most additional tool row have a lateral additional tool distance from the centre longitudinal axis that is smaller than or equal to the lateral wheel distance.

Thus, this preferred embodiment can be described so that in the working direction in front of the soil tillage implement described up to now the tool row located furthest in front of the running gear in the working direction filled towards the outside up to the complete working width of the soil tillage implement by additional tools, a further row of additional tools is arranged in front of the row filled up thus and in front of that a further additional tool row is arranged, which for example, is just as wide as the tool row located furthest in front of the running gear in the working direction.

Through this configuration of the soil tillage implement, the advantages of the invention can also be expanded to such soil tillage implements as comprise cultivator tines and additional tools and should thereby be designed so that both the cultivator tines and also the additional tools are each arranged in a compact and manoeuvrable manner free of side draft and evenly.

Here it is preferred that the additional tools of the rear-most disc row located next to the centre longitudinal axis are arranged in the working direction aligned in front of the main wheels of the running gear. This configuration results in that earth thrown up by the additional tools gets in front of the main wheels of the running gear and is compacted by these, which altogether has as a consequence a more even soil tillage because the main wheels otherwise compact the soil formed without additional earth and can thus result in tracking grooves without alternative or additional counter-measures.

Here it is preferred, furthermore, that with respect to the working direction to the left and right next to the front-most additional tool row and in the same position along the working direction as this additional tool row at least one support wheel each is arranged, so that the additional tools of this additional tool row are flanked by the support wheels. By way of this, the same effects as explained above regarding the support wheels flanking the soil tillage tools, i.e. the cultivator tines, are achieved with respect to the additional tools.

In a preferred embodiment, the additional tools are arranged obliquely and are preferentially hollow discs by way of which the respective one throwing direction is defined, wherein the throwing direction of the additional tools of the rear-most additional tool row points towards the centre longitudinal axis, the throwing direction of the additional tools of the additional tool rows arranged one behind the other, point alternately away from the centre longitudinal axis and towards the centre longitudinal axis.

Through this configuration and arrangement of the additional tools, as even as possible and efficient soil tillage at the same time can be achieved through the additional tools. The piling up of earth in the middle or at the edges of the working width that is often problematic in the prior art can be bypassed through the present preferred arrangement of the additional tools because the front-most and rear-most additional tool row extends only over a part of the total working width of the soil tillage implement.

Advantageously, the same number of additional tools, in particular the same number of additional tools per row, is arranged on both sides outside the centre longitudinal axis. This means that for example in the case of an uneven number of additional tools per row, additional tools can also be arranged centrally, i.e. on the centre longitudinal axis. Through this arrangement, an operation of the soil tillage implement free of side draft can be particularly favourably achieved.

It is preferred, furthermore, that the respective additional tool of the rear-most additional tool row arranged furthest inside on the centre longitudinal axis is positioned so that in the working direction it is located aligned in front of a main wheel of the running gear. In this way, earth can be conveyed in front of the main wheel of the running gear during the operation, which can be compacted by the main wheel in order to at least partly compensate for a compaction of the soil that would otherwise occur in this case and a tracking groove accompanied by this. Thus, an improvement of the evenness of the soil tillage can be achieved which reduces the effort of a subsequent levelling and increases the quality of the soil tillage. In other words, a levelling or at least a reduction of a lateral dam that would otherwise occur is thus achieved by being rolled-over by the wheel.

Preferably, a depth guidance of the soil tillage tools and alternatively or additionally of the disc tools takes place by way of the main wheel or the main wheels of the running gear, wherein any existing support wheels can assist during this depth guidance.

Furthermore, one or more rollers and/or one or more flexible harrows can be arranged behind the soil tillage tools as levelling tools.

In a preferred embodiment, at least one of the additional tools which is located on the centre longitudinal axis or directly adjacent to the same, is displaced relative to the other additional tools of its additional tool row in the working direction towards the front or back, preferentially by ⅓ times to ½ times it's longitudinal extent along the working direction. The dimension of the displacement is preferably at the same time 30% or more, further preferably 50% or more of a diameter of the additional tool when the same is disc-shaped.

Thus, a risk of clogging caused by material wrapping about the additional tools that otherwise exists in the case of additional tools located closely together can be reduced or prevented.

Preferably, a total number n_ges of soil tillage tools satisfies the following equation:

n_ges=nh+(R−1)*(nh−1),=nh+(R−1)*(nh−1),

wherein nh refers to a number of soil tillage tools of the rear-most tool row and R refers to a number of main tool rows substantially extending over the working width. In a particularly preferred embodiment with three main tool rows and ten soil tillage tools in the rear-most tool row the total number n_ges of soil tillage tools 10+2*9=28 is obtained. If the soil tillage implement were to be wider and have in its rear-most of three main tool rows 12 soil tillage tools, a total number n_ges of 12+2*11=34 would be obtained and in the case of a longer soil tillage implement with four main tool rows and ten soil tillage tools in the rear-most main tool row a total number n_ges of 10+3*9=37 soil tillage tools would be obtained.

The preferred soil tillage implement thus comprises R main tool rows, on which altogether n_ges soil tillage tools laterally spaced apart from one another are fastened. The soil tillage implement comprises a middle as well as a right and left frame region which are arranged along the main tool rows. The rear-most main tool row is assigned a continuous number nh of soil tillage tools which define the working width B.ges, wherein the soil tillage tools of the rear-most main tool row are continuously arranged at the same spacing bz=B.ges/nh. The right and left frame region in the rear-most main tool row are assigned a same number (nhr=nhl) of soil tillage tools and the main tool rows lying in front of these respectively in the right and left frame region are assigned a reduced number (nhr−1, nhl−1) of soil tillage tools. The middle frame region is assigned the running gear, which interrupts at least one of the main tool rows in the middle frame region arranged in front of the rear-most main tool row. Here, two or more soil tillage tools of the main tool rows interrupted by the running gear fall away in the middle frame region relative to an arrangement of the soil tillage tools in which the rear-most and each main tool row located in front of the same has the same number of soil tillage tools in the middle frame region. In order to compensate for this, the omitted soil tillage tools are arranged in an additional part tool row in front of the main tool rows that is only assigned to the middle frame region. Thus, the total number n_ges corresponds to the soil tillage tools of the soil tillage implement of the above equation n_ges_=nh+(R−1)*(nh−1).

In a preferred embodiment, the soil tillage implement comprises a number R of main tool rows substantially extending over the entire working width of the soil tillage implement, wherein a lateral tine spacing between the soil tillage tools is equal to a larger lateral tool distance from the centre longitudinal axis than the lateral wheel distance. Furthermore, the soil tillage tools with a greater lateral tool distance from the centre longitudinal axis than the lateral wheel distance are displaced from the inside from the rear-most tool row towards the front between tool rows located one behind the other in each case by 1/R times the tine spacing towards the centre longitudinal axis, i.e. staggered. This thus describes an existing arrangement of the soil tillage implements each extending towards the inside from the rear to the front in the region outside the region about the centre longitudinal axis delimited by the running gear.

Further preferably, there is a distance between the soil tillage tools having a maximally same lateral tool distance from the centre longitudinal axis as the lateral wheel distance. This distance is to mean the direct distance in any direction between adjacent soil tillage tools. The amount of this distance is at least as great, i.e. greater than or equal to, as the amount of the distance between the soil tillage tools with a greater lateral tool distance from the centre longitudinal axis than the lateral wheel distance. In other words, the soil tillage tools within the region about the centre longitudinal axis delimited by the running gear do not stand closer to one another than the soil tillage tools outside this region, so that an accumulation of for example plant remnants between the soil tillage tools and thus a clogging of the implement in the inner region is just as improbable as outside this region.

Through the present invention a soil tillage implement with soil tillage tools is provided, in which the soil tillage tools are arranged so that a high level of manoeuvrability, neat connecting runs and an even soil tillage are achieved. An optimum installation space utilisation of the frame area is achieved in order to be able to produce the implement in as compact and efficient a manner.

Further advantages and further developments of the invention are obtained from the following figure description and the totality of the claims.

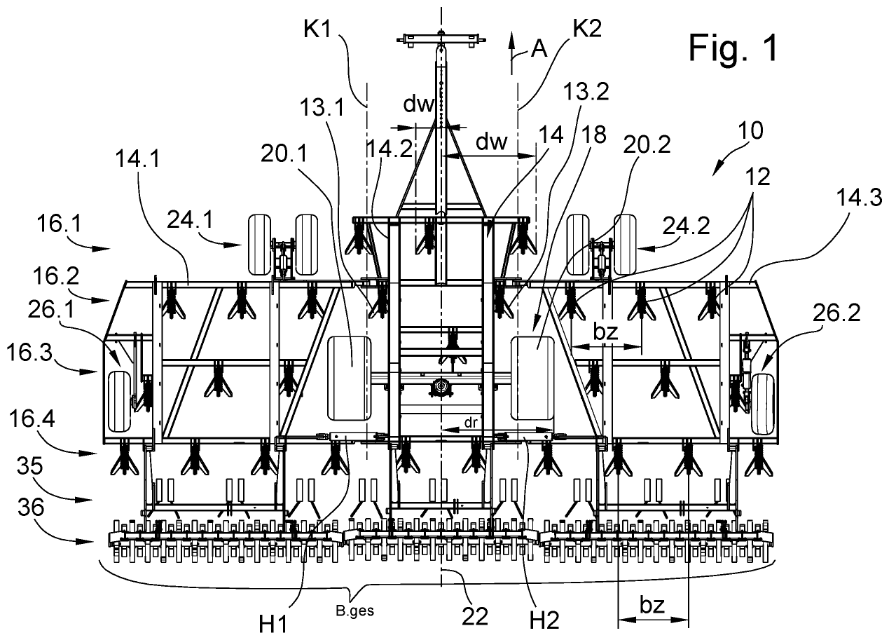

FIG. 1 shows a plan view of a soil tillage implement in a first preferred embodiment.

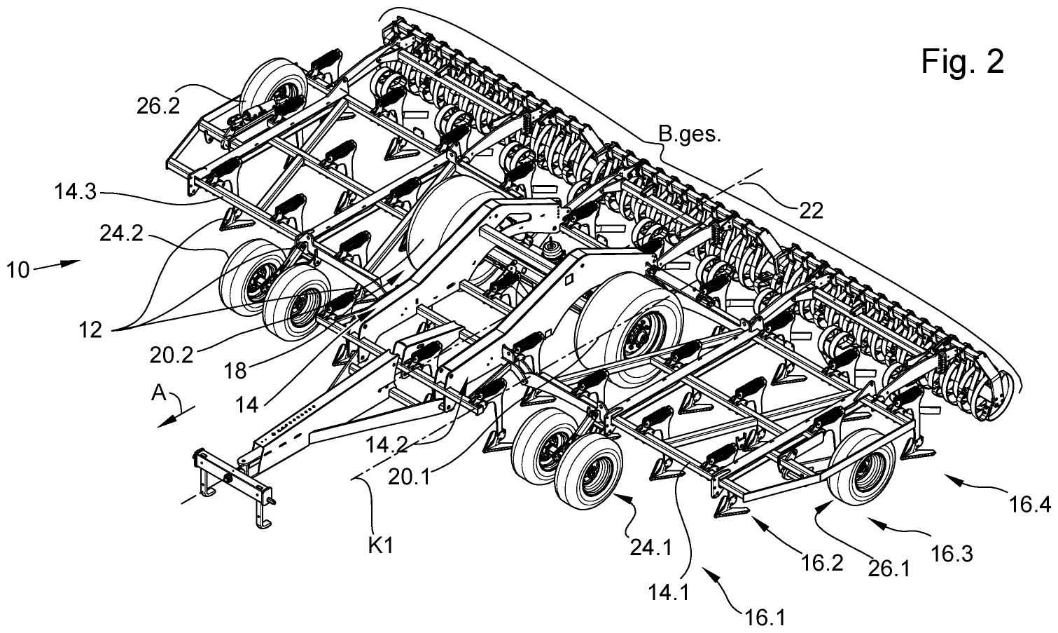

FIG. 2 shows a perspective view of the soil tillage implement from FIG. 1.

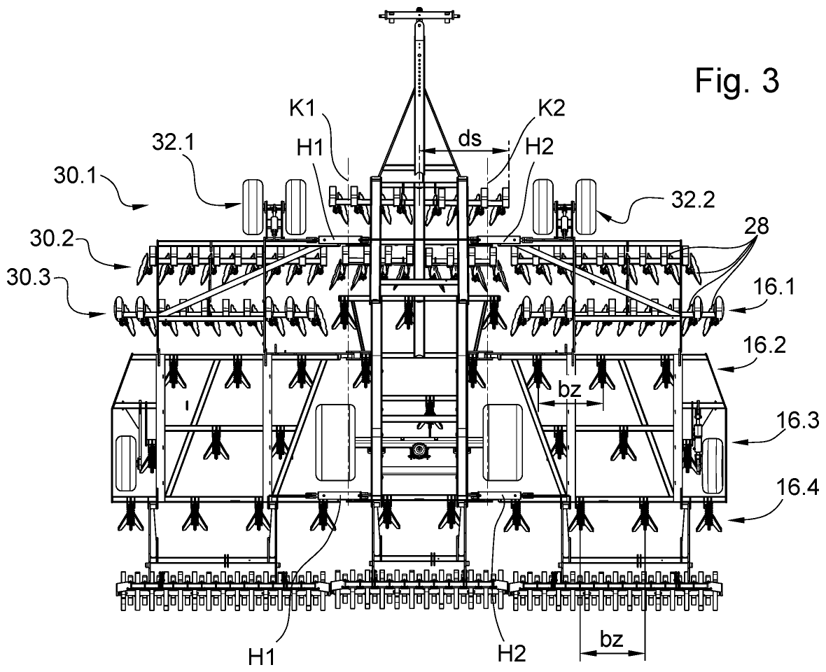

FIG. 3 shows a plan view of a soil tillage implement in a second preferred embodiment.

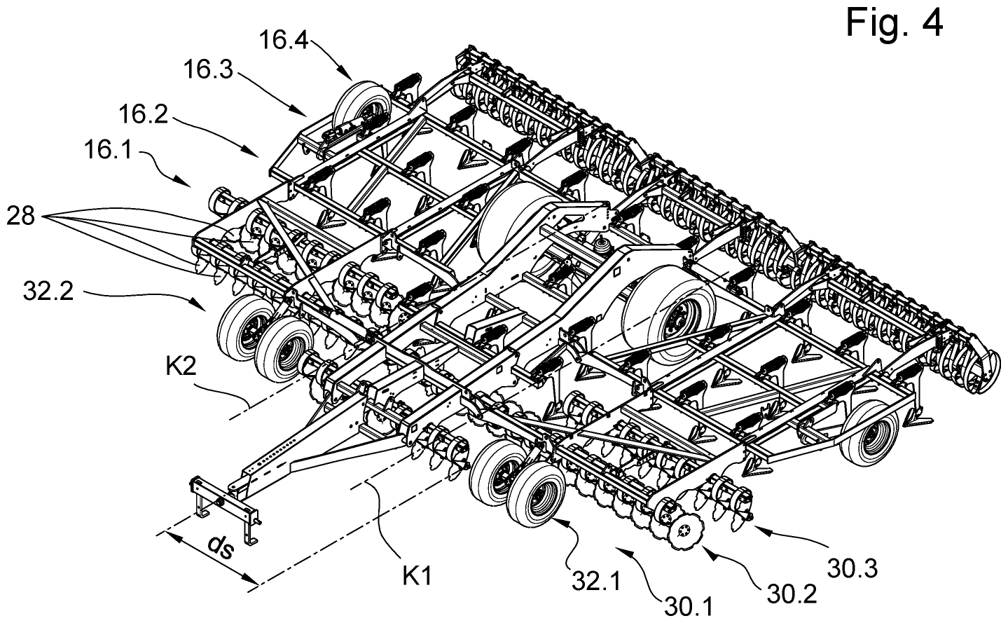

FIG. 4 shows a perspective view of the soil tillage implement from FIG. 3.

In the following description, same reference numbers are used for same or corresponding elements and a repetitive description largely avoided.

FIG. 1 shows a plan view of a wing share cultivator 10 in a first preferred embodiment. The cultivator 10 comprises a frame 14 with a middle frame segment 14.2, a left lateral frame segment 14.1 and a right lateral frame segment 14.3. The directions left and right are based on a working direction A, in which the cultivator 10 is pulled during its working operation. For this purpose, the cultivator 10 is coupled to a tractor by way of a towbar in the known manner. The frame segments 14.1 and 14.3 are movably interconnected with the metal frame segment 14.2 via folding axes K1 and K2 and can be preferentially brought via actuators H1 and H2 from a laterally extending working position into a vertical transport position.

In order to support the load of the cultivator 10 a running gear 18 is integrated in the frame 14. The running gear 18 includes two main wheels 20.1, 20.2 that are spaced apart from a centre longitudinal axis 22 equidistantly to the left and right, 25 which have a lateral wheel distance dr from the centre longitudinal axis 22 and carry the metal frame segment 14.2 by way of an axle. Complementarily to the running gear 18, the cultivator additionally includes a pair of front support wheels 24.1, 24.2 and rear support wheels 26.1, 26.2, which in each case flank a row of cultivator tines 12. Through the hinging effect of the folding axes K1 and K2 an 30 adaptation of the working depth of the respective frame segments 14.1, 14.2 and 14.3 to soil irregularities that occur transversely to the main working direction can take place with the help of the further support wheels 24.1, 24.2 and/or 26.1, 26.2 also with the help of the actuators H1 and H2.

In the present embodiment, the cultivator tines 12 are arranged in three main tool rows 16.2, 16.3, 16.4 which run transversely to the working direction A and are arranged in the working direction A one behind the other. Behind the last main tool row 16.4, whose lateral extent defines a total working width B.ges of the cultivator 10, levelling tools such as rollers 36 or flexible harrows 35 are additionally provided. By way of the rollers 36, a re-compacting effect for the soil loosened by way of the soil tillage tools (12) and/or a depth guidance for the soil tillage tools (12) can be additionally achieved.

In the last main tool row 16.4, ten cultivator tines 12 each at the same lateral tine spacing from one another are arranged, wherein five cultivator tines 12 are arranged to the left of the centre longitudinal axis 22 and five cultivator tines 12 to the right of the centre longitudinal axis 22.

In the working direction A in front of the last main tool row 16.4 a middle main tool row 16.3 including seven cultivator tines 12 is located. In the middle main tool row 16.3, the main wheels 20.1, 20.2 of the running gear 18 are also integrated and between the main wheels 20.1, 20.2 a cultivator tine 12 is slightly displaced towards the front in the working direction, wherein this cultivator tine 12 is nevertheless defined as belonging to the middle main tool row 16.3, since its distance in the working direction A to the laterally adjacent cultivator tines 12 of the middle main tool row 16.3 is less than half the share step, i.e. the distance in the working direction A between consecutive main tool rows 16.2 . . . 16.4. At the lateral ends of the middle main tool row 16.3 the respective outer-most cultivator tines 12 are slightly displaced towards the rear in the working direction A and are thus located behind a front edge of the rear support wheels 26.1, 26.2 arranged next to these. These outer-most cultivator tines 12 also belong to the middle main tool row 16.3 since its distance in the working direction A to the laterally adjacent cultivator tines 12 of the middle main tool row 16.3 is less than half the share step.

The cultivator tines 12 of the middle main tool row 16.3 are positioned relative to the cultivator tines of the last main tool row 16.4 so that for each cultivator tine 12 of the middle main tool row 16.3 there is a cultivator tine 12 of the last main tool row 16.4 which is displaced relative to this by a third of the tine spacing of the cultivator tines 12 in the last main tool row 16.4 in the direction of the centre longitudinal axis to the inside. This arrangement contributes to an even working pattern by the cultivator 10, wherein the main wheels 20.1, 20.2 take the place of two cultivator tines 12 of this pattern.

In the working direction A in front of the middle main tool row 16.3 is located the front main tool row 16.2 including the eight cultivator tines 12. The cultivator tines 12 of the front main tool row 16.2 are arranged relative to the middle main tool row 16.3 according to the same pattern as the cultivator tines 12 of the middle main tool row 16.3 relative to those of the last main tool row 16.4. In other words, the cultivator tines 12 of the front main tool row 16.2 are displaced by a third of the tine spacing of the cultivator tines 12 of the last main tool row 16.4 in the direction of the centre longitudinal axis 22 to the inside. Since in the middle main tool row 16.3 the main wheels 20.1, 20.2 take up the place of a cultivator tine 12 each, this regularity does not apply to the innermost cultivator tines 12 of the front main tool row 16.2, but which have a corresponding relative position to the main wheels 20.1, 20.2, i.e. the innermost cultivator tines 12 of the front main tool row 16.2 are each displaced relative to one of the main wheels 20.1, 20.2 by a third of the tine spacing of the cultivator tines 12 in the last main tool row 16.4 in the direction of the centre longitudinal axis to the inside.

In the working direction A in front of the front main tool row 16.2 is located the tool row 16.1 situated furthest in front of the running gear 18 in the working direction A, which is a part tool row since it extends over less than half of the total working width B.ges of the last main tool row 16.4. The cultivator tines 12 of this tool row 16.1 located furthest in front of the running gear 18 in the working direction A have a lateral tool distance dw from the centre longitudinal axis 22 that is smaller than the lateral wheel distance dr.

The tool row 16.1 located furthest in front of the running gear 18 in the working direction A is flanked by two front support wheels 24.1, 24.2. A great advantage of the preferred embodiment consists in that the tool row 16.1 is provided with three cultivator tines 12 in such a manner that an even working pattern of the cultivator 10 is created. Through its narrow embodiment it is ensured at the same time that the cultivator 10 is highly manoeuvrable. The cultivator 10 of the preferred embodiment is more manoeuvrable than a cultivator having four main tool rows 16.2 . . . 16.4 substantially spread over the entire working width B.ges. In other words, the cultivator 10 can follow a small turning circle. However, other than in the prior art, the high level of manoeuvrability is not at the expense of the evenness of the soil tillage since the displacement of the cultivator tines of tool rows arranged one behind the other in each case is a third of the tine spacing in the last main tool row 16.4. This facilitates levelling by a roller or flexible harrow behind the cultivator tines 12.

This preferred embodiment makes possible to very evenly arrange 28 cultivator tines 12 in a compact frame 14 with integrated running gear 18 and thus a high level of manoeuvrability so that a highly homogeneous working pattern is created and thereby a high-quality soil tillage is possible.

FIG. 2 shows a perspective view of the soil tillage implement from FIG. 1, wherein the same reference numbers as in FIG. 1 are used.

FIG. 3 shows a plan view of a soil tillage implement in a second preferred embodiment. A large part of the elements shown in FIG. 3 is equal to those of the first preferred embodiment shown in FIG. 1. This first preferred embodiment from FIG. 1 is complemented, according to the second preferred embodiment from FIG. 3, by three disc rows 30.1 . . . 30.3. The three disc rows 30.1 . . . 30.3 follow in the working direction A in front of the main tool rows 16.2 . . . 16.4.

Seen in the working direction A, a rear disc row 30.3 is in the same place as the tool row 16.1 and laterally flanks this tool row 16.1. The disc rows 30.1 . . . 30.3 include multiple hollow discs 28 as disc tools each defining a throwing direction. The hollow discs 28 of the last disc row 30.3 are oriented and arranged so that their throwing direction points to the inside towards the centre longitudinal axis 22.

In front of the rear disc row 30.3 a continuous middle disc row 30.2 substantially running over the entire working width B.ges is arranged. The hollow discs 28 of the middle disc row 30.2 have a throwing direction that points to the outside away from the centre longitudinal axis 22.

Again in front of the middle disc row 30.2 a front disc row 30.1 is arranged, which extends approximately over the same lateral extent as the main tool row 16.1. The throwing direction of the hollow discs 28 of the front disc row 30.1, like that of the hollow discs 28 of the rear disc row 30.3, points to the inside towards the centre longitudinal axis 22. It is true for the hollow discs 28 of the front disc row 30.1 that a lateral disc distance ds of all hollow discs 28 to the centre longitudinal axis 22 is smaller than or equal to the wheel distance dr.

Similar to the cultivator tines 12 of the front tool row 16.1 in the first preferred embodiment from FIG. 1, the hollow discs 28 of the front disc row 30.1 are flanked by the front support wheels 32.1, 32.2. In contrast with the first preferred embodiment from FIG. 1, no support wheels are arranged in this second preferred embodiment next to the cultivator tines 12 of the tool row 16.1.

By selecting and distributing the throwing directions of the hollow discs 28 via the disc rows 30.1 . . . 30.3 a preparation of the soil that takes place symmetrically and comparatively evenly is possible. Thus, a synergy with the arrangement of the cultivator tines 12 materialises insofar as the even and symmetrical soil tillage through the cultivator tines 12 is very well prepared by the hollow discs 28 in the arrangement according to the second preferred embodiment from FIG. 3.

FIG. 4 shows a perspective view of the soil tillage implement from FIG. 3, wherein the same reference numbers as in FIG. 3 are used.

### LIST OF REFERENCE NUMBERS

| | |
|---|---|
| 10 | Soil tillage implement |
| 12 | Soil tillage tools, cultivator tines |
| 13.1, 13.2 | Soil tillage tools |
| 14 | Frame |
| 14.1 | Left lateral frame segment |
| 14.2 | Middle frame segment |
| 14.3 | Right lateral frame segment |
| 16.1 . . . 16.4 | Tool row |
| 18 | Running gear |
| 20.1, 20.2 | Main wheel |
| 22 | Centre longitudinal axis |
| 24.1, 24.2 | Front support wheel |
| 26.1, 26.2 | Rear support wheel |
| 28 | Disc tools, hollow discs |
| 30.1, 30.2 | Disc rows |
| 32.1, 32.2 | Front support wheel |
| 35 | Flexible harrow |
| 36 | Roller |
| A | Working direction |
| B. ges | Working width |
| dr | Wheel distance |
| dw | Tool distance |
| bz | Tine spacing |
| ds | Disc distance |
| K1, K2 | Folding axis |
| H1, H2 | Actuator |

1. A soil tillage implement (10) having soil tillage tools (12), in particular cultivator tines,
wherein the soil tillage implement (10) comprises a frame (14), in order to arrange the soil tillage tools (12) in multiple tool rows (16.1 . . . 16.4) over a frame area that follow one another in the working direction (A) and are oriented transversely to the working direction (A), and
a running gear (18) having at least one main wheel (20.1, 20.2), which is spaced apart transversely to the working direction (A) from a centre longitudinal axis (22) by a lateral wheel distance (dr),
wherein the running gear (18) is arranged within the frame area in such a manner that with respect to the working direction (A) in front of and preferably behind the running gear (18) as well as to the left and right of the running gear (18) at least one soil tillage tool (12) is arranged,
characterised
in that all soil tillage tools (120 which are arranged in the tool row (16.1) located furthest in front of the running gear (18) in the working direction (A) have a lateral tool distance (dw) from the centre longitudinal axis (22) that is smaller than or equal to the lateral wheel distance (dr).

2. The soil tillage implement (10) according to claim 1,
wherein the running gear (18) comprises two main wheels (20.1, 20.2) which are each spaced apart by the same lateral wheel distance (dr) from the centre longitudinal axis (22).

3. The soil tillage implement (10) according to claim 1,
wherein all soil tillage tools (12) arranged in the working direction (A) in the rear-most tool row (16.4) are equidistantly spaced apart from their laterally adjacent soil tillage tools (12) of the same tool row (16.4), namely by a tine spacing (bz).

4. The soil tillage implement (10) according to claim 3,
wherein the tool row (16.1) located furthest in front of the running gear (18) in the working direction is a part tool row which extends over less than half of a working width (B) of the soil tillage implement (10),
wherein the soil tillage tools (12) of the soil tillage implement (10) are arranged in a number R, preferably three, of main tool rows (16.2, 16.3, 16.4) substantially extending over the entire working width (B.ges) of the soil tillage implement (10),
wherein each of the soil tillage tools (12) of a main tool row (16.2, 16.3) in the working direction (A) in front of the rear-most main tool row (16.4), whose lateral tool distance (dw) from the centre longitudinal axis (22) is greater than the lateral wheel distance (dr), is displaced relative to one of the soil tillage tools (12) of the main tool rows (16.2, 16.3, 16.4) directly adjoining in the working direction (A) at the back by 1/R-times the tine spacing (bz) to the inside towards the centre longitudinal axis (22) and
wherein the running gear (18) is arranged with respect to the working direction (A) in a region of a main tool row (16.2, 16.3) in front of the rear-most main tool row (16.4).

5. The soil tillage implement (10) according to claim 1, wherein on both sides outside the centre longitudinal axis (22) the same number of soil tillage tools (12) are arranged.

6. The soil tillage implement (10) according to claim 1,
wherein with respect to the working direction (A) to the left and right next to the tool row (16.1) located furthest in front of the running gear (18) in the working direction (A) and along the working direction (A) in the same position as this tool row (16.1), at least one front support wheel (24.1, 24.2) each is arranged, so that the soil tillage tools (12) of this tool row (16.1) are flanked by the front support wheels (24.1, 24.2).

7. The soil tillage implement (10) according to claim 1,
wherein to the left and right with respect to the working direction (A) next to a tool row (16.2, 16.3) in front of the rear-most tool row (16.4) but behind the tool row (16.1) located furthest in front of the running gear (18) in the working direction, in particular of the penultimate tool row (16.3), at least one rear support wheel (26.1, 26.2) each is arranged, so that the soil tillage tools (12) of this tool row (16.2, 16.3) are flanked by the rear support wheels (26.1, 26.2),
wherein preferably aligned in the working direction (A) behind the respective at least one rear support wheel (26.1, 26.2) a soil tillage tool (12) is arranged, which is arranged in particular in the last tool row (16.4).

8. The soil tillage implement (10) according to claim 1,
wherein some soil tillage tools (12) are arranged on a middle frame segment (14.2) and of these two or more soil tillage tools (12) form the tool row (16) located furthest in front of the running gear (18) in the working direction (A) and
wherein preferably a plurality each of soil tillage tools (12) is arranged on a left lateral frame segment (14.1) and a right lateral frame segment (14.3),
wherein the lateral frame segments (14.1, 14.3) are each preferably foldable relative to the middle frame segment (14.2) about a folding axis (K1, K2) running parallel to the working direction (A) in order to switch the soil tillage implement (10) between a working position and a transport position,
wherein preferably the running gear (18) is arranged on the middle frame segment (14.2) and wherein support wheels (24.1, 24.2, 26.1, 26.2) are optionally arranged on the lateral frame segments (14.1, 14.3).

9. The soil tillage implement (10) according to claim 1,
wherein the soil tillage tools (12) are cultivator tines,
wherein the soil tillage implement (10) furthermore comprises additional tools which have a clearing or levelling effect, preferentially rotating tools, preferentially disc tools (28), which are arranged in the working direction (A) in front of the cultivator tines (12) in multiple additional tool rows (30.1, 30.2, 30.3) following one another in the working direction (A) and oriented transversely to the working direction (A),
wherein a rear-most additional tool row (30.3) is arranged substantially with respect to the working direction (A) to the left and right next to the tool row (16.1) located furthest in front of the running gear (18) in the working direction (A) and along the working direction (A) in the same position as this tool row (16.1),
wherein in the working direction (A) in front of the rear-most additional tool row (30.3) a front-most additional tool row (30.1) is arranged,
wherein preferably in front of the rear-most additional tool row (30.3) a middle additional tool row (30.2) and in the working direction (A) in front of the middle additional tool row (30.2) the front-most additional tool row (30.1) is arranged, and
wherein all additional tools (28) which are arranged in the front-most additional tool row (30.1), have a lateral additional tool distance (ds) from the centre longitudinal axis (22) that is smaller than or equal to the lateral wheel distance (dr).

10. The soil tillage implement (10) according to claim 9,
wherein the disc tools (28) of the rear-most additional tool row (30.3) located nearest to the centre longitudinal axis (22) are arranged aligned in the working direction (A) in front of the main wheels (20.1, 20.2) of the running gear (18).

11. The soil tillage implement (10) according to claim 9,
wherein with respect to the working direction (A) to the left and right next to the front-most additional tool row (30.1) and along the working direction (A) in the same position as this additional tool row (30.1) at least one front support wheel (32.1, 32.2) each is arranged, so that the additional tools (28) of this additional tool row (30.1) are flanked by the support wheels (32.1, 32.2).

12. The soil tillage implement (10) according to claim 9,
wherein the additional tools (28) are arranged obliquely and preferentially are hollow discs, through which in each case a throwing direction is defined,
wherein the throwing direction of the additional tools (28) of the rear-most additional tool row (30.3) points to the centre longitudinal axis (22) and
wherein the throwing directions of the additional tools (28) of the additional tool rows (30.1, 30.2, 30.3) arranged one behind the other alternately point away from the centre longitudinal axis (22) and towards the centre longitudinal axis (22).

13. The soil tillage implement (10) according to claim 9,
wherein at least one of the additional tools (28), which is located on the centre longitudinal axis (22) or directly adjacent to the same, is displaced relative to the other additional tools (28) of its additional tool row (30.1, 30.2, 30.3) in the working direction (A) to the front or rear, preferentially by ⅓-times to ½-times its longitudinal extent along the working direction (A).

14. The soil tillage implement (10) according to claim 9,
wherein on both sides outside the centre longitudinal axis (22) the same number of additional tools (28) per additional tool row (30.1 . . . 30.3) is arranged.

15. The soil tillage implement (10) according to claim 9,
wherein a total number n_ges of soil tillage tools (12) satisfies the following equation:
n_ges=nh+(R−1)*(nh−1),
wherein nh refers to a number of soil tillage tools (12) of the rear-most tool row (16.4) and R refers to a number of main tool rows (16.2, 16.3, 16.4) substantially extending over the working width (B.ges).

16. The soil tillage implement (10) according to claim 9,
which comprises a number R of main tool rows (16.2, 16.3, 16.4) extending substantially over the entire working width (B.ges) of the soil tillage implement (10),
wherein a lateral tine spacing (bz) between the soil tillage tools (12) is equal to a greater lateral tool distance (dw) from the centre longitudinal axis (22) than the lateral wheel distance (dr) and
wherein the soil tillage tools (12) with a greater lateral tool distance (dw) from the centre longitudinal axis (22) than the lateral wheel distance (dr) are displaced from the rear-most tool row (16.4) towards the front between tool rows (16.1 . . . 16.4) located one behind the other in each case by 1/R-times the tine spacing (bz) towards the centre axis (22) to the inside, i.e. are staggered.

17. The soil tillage implement (10) according to claim 16,
wherein between the soil tillage tools (12) with a maximally same lateral tool distance (dw) from the centre longitudinal axis (22) as the lateral wheel distance (dr) there is a distance whose amount is at least as great as the amount of the distance between the soil tillage tools (12) with a greater lateral tool distance (dw) from the centre longitudinal axis (22) than the lateral wheel distance (dr).
